(19) United States
(12) Patent Application Publication
(10) Pub. No.: US 2014/0215399 A1
(43) Pub. Date: Jul. 31, 2014

(54) ONSCREEN MESSAGING SYSTEM

(71) Applicant: Timothy W. Clark, Albany, CA (US)

(72) Inventor: Timothy W. Clark, Albany, CA (US)

(21) Appl. No.: 14/169,663

(22) Filed: Jan. 31, 2014

Related U.S. Application Data
(60) Provisional application No. 61/759,351, filed on Jan. 31, 2013.

(51) Int. Cl. G06F 3/0482

(52) U.S. Cl. CPC G06F 3/0482
USPC 715/825

(57) ABSTRACT

In one embodiment, the present invention provides a cross platform computer application that displays onscreen messages in the form of text, images and videos. Single messages, images and videos can be bundled into message sets. The main functions of the application are creating or acquiring and storing sets of messages, which can be retrieved, edited, managed, and shared with others. Chosen message sets can be viewed on the user's computing device or TV with several onscreen display options including, but not limited to the frequency of messages, their duration, their size and onscreen position.

### CROSS-REFERENCES TO RELATED APPLICATIONS

This application claims the benefit of Provisional Application No. 61/759,351, entitled “Gentle Reminders—Mindfulness App”, filed Jan. 31, 2013, which disclosure is incorporated herein in its entirety

### BACKGROUND OF THE INVENTION

A variety of message systems exist for providing reminders, such as reminders to take pills, calendar reminders, or reminders to stretch. However, such systems typically are directed to a single, particular use, or are general, requiring a user to enter all the content.

### BRIEF SUMMARY OF THE INVENTION

In one embodiment, the present invention provides a cross platform computer application that displays onscreen messages in the form of text, images and videos. Single messages, images and videos can be bundled into message sets. The main functions of the application are creating or acquiring and storing sets of messages, which can be retrieved, edited, managed, and shared with others. Chosen message sets can be viewed on the user's computing device or TV with several onscreen display options including, but not limited to the frequency of messages, their duration, their size and onscreen position.

In another embodiment, the present invention provides a cross platform computer application that displays onscreen messages in the form of text, images and videos. Single messages, images and videos can be composed into sets. The main functions of application are creating message sets, editing, managing, sharing, acquiring and viewing. Bundled sets of messages (message sets) can be composed, edited, managed, shared and acquired through a web-based program. The message viewer runs independently from the internet. There are several onscreen display options including, but not limited to the frequency of messages, their duration, their size and onscreen position.

In another embodiment, the present invention provides a cross platform software application that displays onscreen messages composed of text, images, videos and other media content (including the major generic or non-proprietary MIME content types supported by HTTP and HTML).

### BRIEF DESCRIPTION OF THE DRAWINGS

FIG. 1 is a diagram of the content of a system and example content according to one embodiment of the invention.

FIG. 2 is a diagram of a message set menu according to one embodiment of the invention.

FIG. 3 is a diagram of a playlist menu according to one embodiment of the invention.

FIG. 4 is a diagram of a Message Set Content Editing page according to one embodiment of the invention.

FIG. 5 is a diagram of a message set publishing template according to one embodiment of the invention.

FIG. 6 is a diagram of a message set marketplace according to one embodiment of the invention.

FIG. 7 is a diagram of the financial accounting aspects of a system according to one embodiment of the invention.

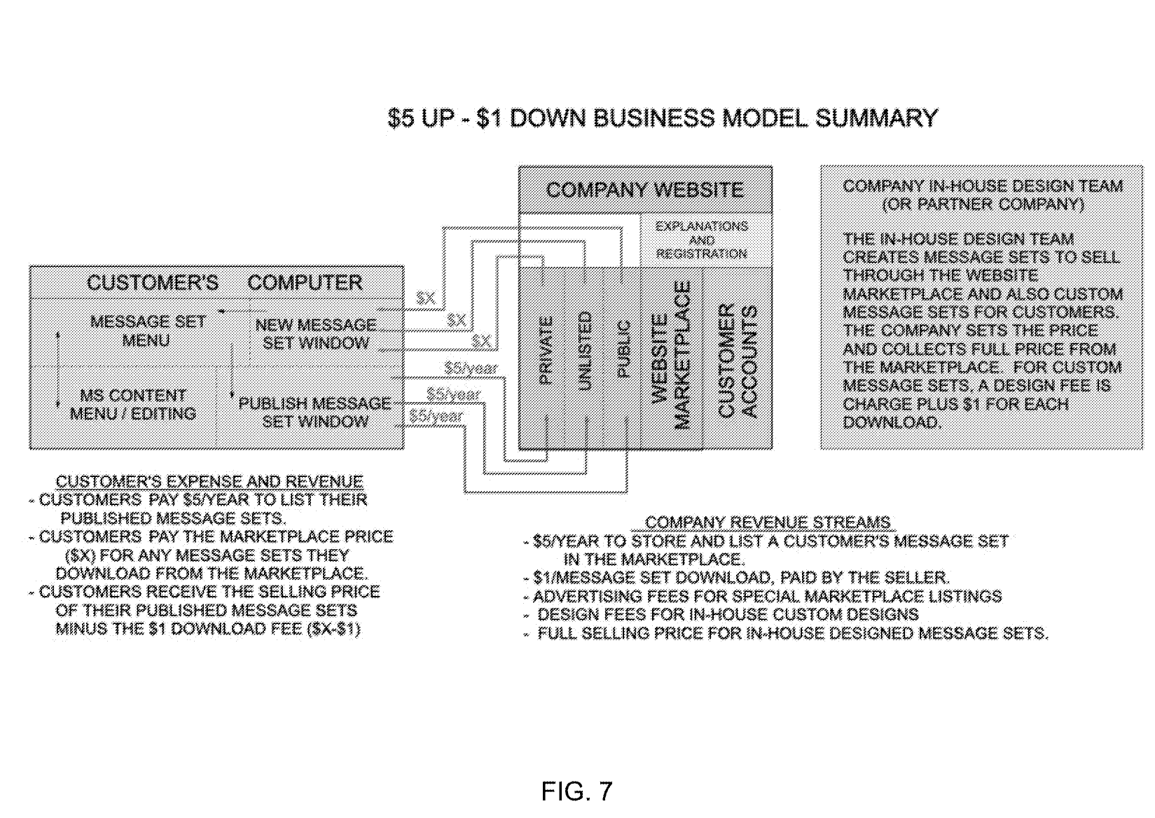

FIG. 8 is a diagram of a message set content menu according to one embodiment of the invention.

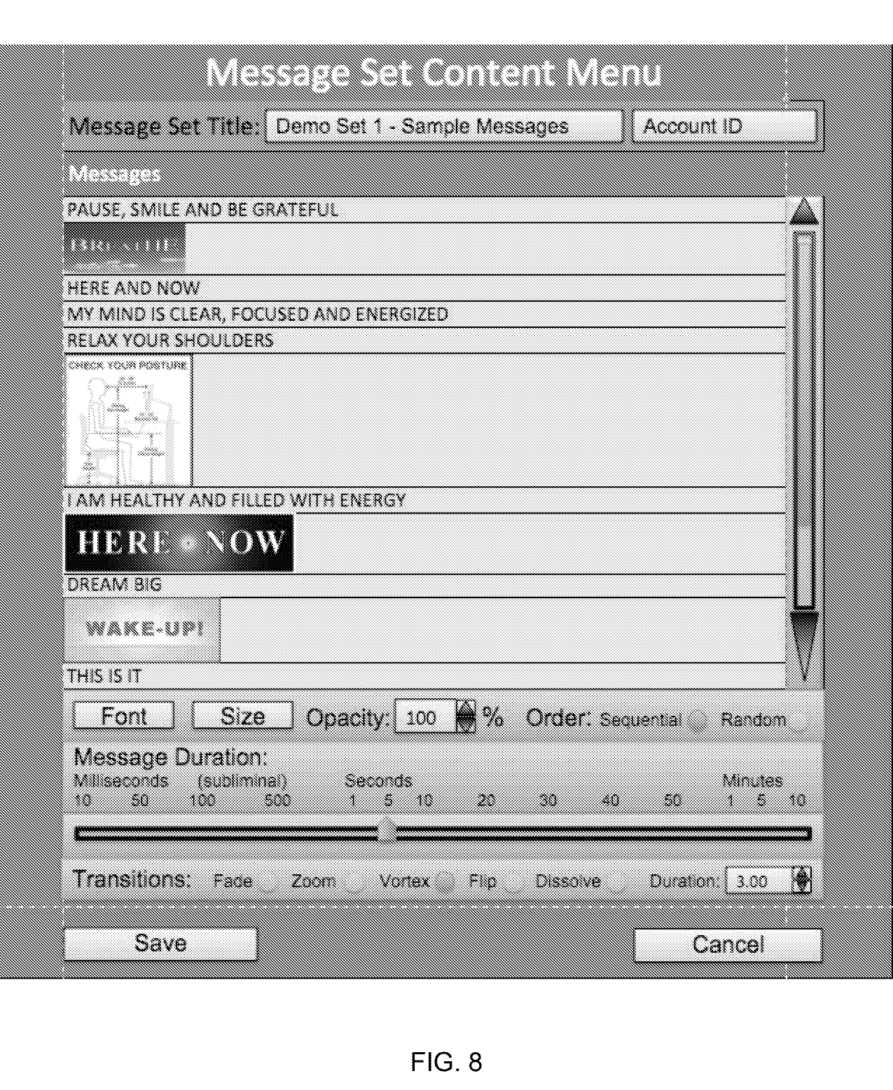

FIG. 9 is a diagram of a message set menu according to one embodiment of the invention.

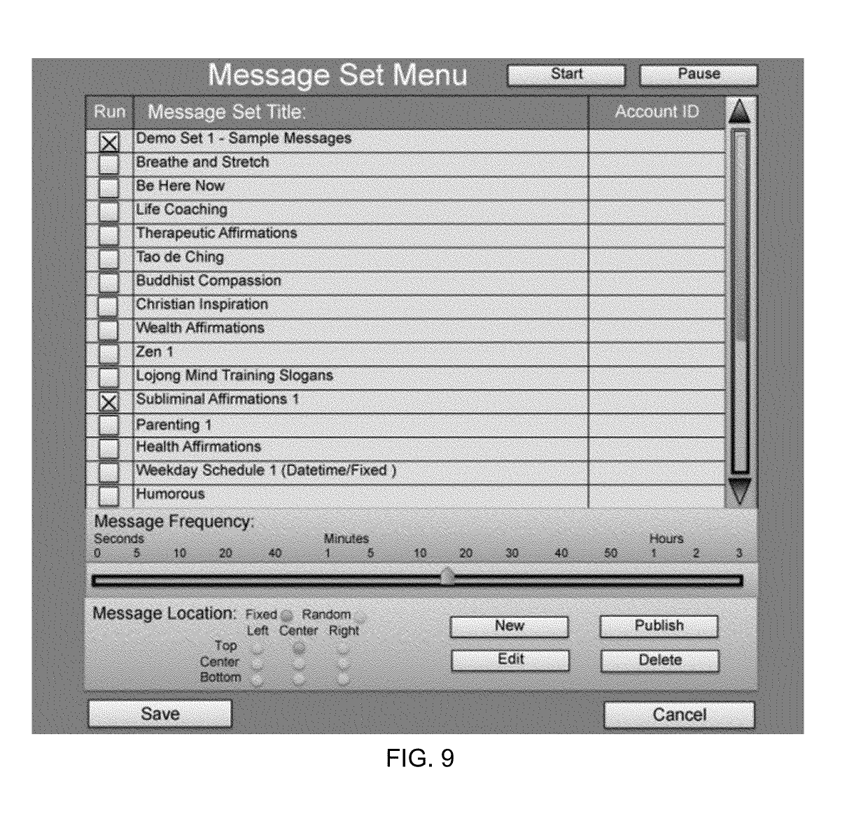

FIG. 10 is a diagram of a new message set menu according to one embodiment of the invention.

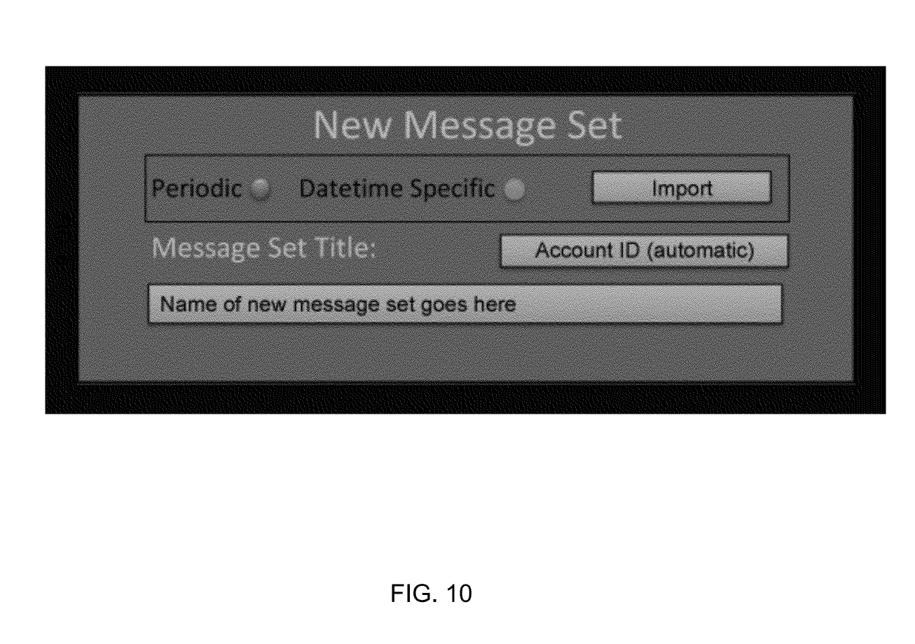

FIG. 11 is a diagram of a message set publishing menu according to one embodiment of the invention.

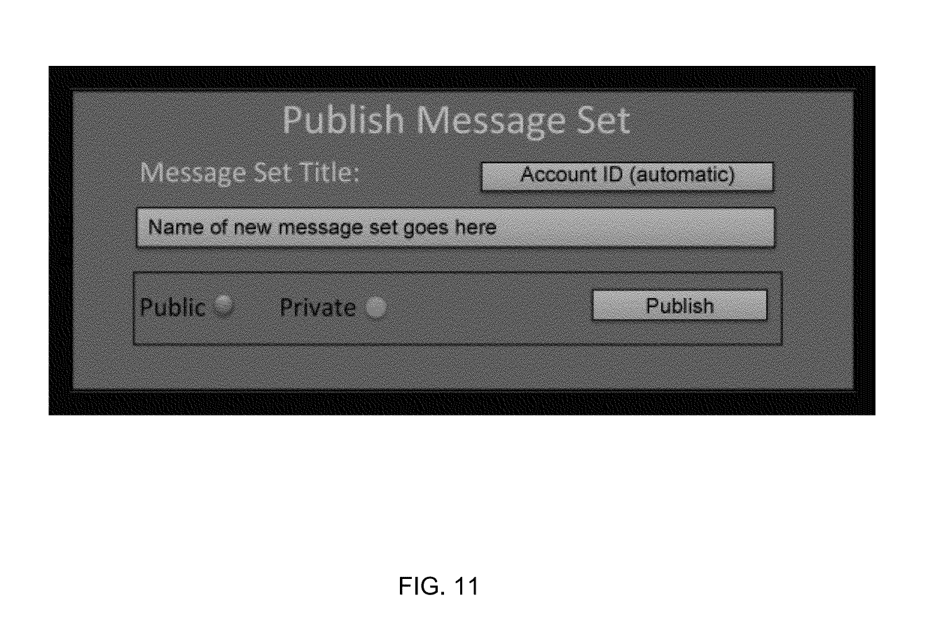

FIG. 12 is a high level block diagram of a computer system that may be used to implement a system described herein.

### DETAILED DESCRIPTION OF THE INVENTION

Sitting in front of a computer for hours a day takes a toll on our bodies: sore backs, tense shoulders stiff necks, tired eyes and repetitive stress injuries. One's mind can become dull and sluggish from prolonged intense concentration and disinterested boredom. When attention is focused on what is happening right at moment, in the mind, in the body and in the immediate environment, the body relaxes and a calm space within the mind is created. An embodiment of the present invention displays brief messages or images on one's computer screen at programmable intervals. There are programmed sets of text messages, images, and audio clips on various subjects available. There are also simple methods for creating and editing one's own messages, the interval between messages and the duration of time that the messages appear on the screen. The various display options, such as location on screen, the opacity and transitions will also be controllable. It is also possible to program messages that are date time specific, for example: “It's 10 am, time for a coffee break” or, “It's 2 pm, take your afternoon medicine.” The program can be a tool for bringing anything to mind. Whatever inspires us or whatever makes us smile. There are a few other computer applications that have similar but less editable functions. This application differs primarily in its business model revenue streams and its ability to share sets of messages with others.

An embodiment of the present invention could benefit many categories of users: Computer users who want to be reminded to be mindful, to correct their posture and to think inspirational thoughts. Psychologists, Life Coaches and other therapists can create custom sets of messages of therapeutic reminders for their clients. Human Resource managers can create message sets to be downloaded by employees.

Reminding office workers to periodically stretch, massage the wrists, rest the eyes, etc. can prevent repetitive stress injuries. Motivational messages can increase productivity. Break times, meeting times and deadlines can be scheduled to appear on workers' computers at appropriate times Spiritual Organizations and Churches can create message sets of inspirational slogans, teachings, prayers and auspicious images. Distributing these sets of reminders to their membership will not only help to train minds but can also produce revenue for the organizations. Parents can use both the periodic and date time specific options to create message sets for their kids. The possible types of messages and benefits are vast.

One embodiment of the present invention provides a message set marketplace. This provides one place where all types of reminders can be found, with templates for producing them.

Embodiments of the invention provide messages on user's mobile devices, tablets, desktop and other platforms. The application can be downloaded or hosted on the cloud (on a server accessed over the Internet or other network). Cross-device functionality can be provided. For example, a user might want different reminders at work (desktop) than when at home or traveling (mobile). With an application in the cloud, someone can access from whatever device, and have it detect which device and load the appropriate template.

One embodiment provides a location based service. The messages or reminders can be varied depending on the location, similarly to varying them depending on the device.

In one embodiment, individuals can customize timing. Alternately, a template with suggested timing can be provided. A user can complete a questionnaire which will automatically generate the correct timing/template for a user, based on religion/spiritual affiliation, physical characteristics, workstation set-up, available exercise tools, etc. Experts in the various fields can generate not only message sets, but also templates, and load them onto the site.

In one embodiment, single messages can be composed into sets of messages (or message sets). In one embodiment, the following functions are included:
composing messages and message sets, as well as message templates (including creating and editing)
publishing messages, message sets and message templates
acquiring and managing messages, message sets and message templates
viewing messages and message sets on the web or on a client platform (desktop computer, tablet, smart phone, etc.)
sharing both messages and information about messages, including comments, rankings and tags

Messages sets can be composed, published, acquired and managed through a web application.

A message viewer application is included that can run on a client platform independently of the internet. The viewer allows the user to set display parameters including (but not limited to) frequency and duration of message display, and size and position on the client platform screen.

A message server application supports both the web application and the client platform application.

The message server application stores and transmits various encodings of structured or actionable data to and from the web application and client application, including data describing:
the form of a message as a template
the content of a message, in various media types
default display settings for a message or message set
identification of messages in a message set
contents providing a description of a message set

Example of internet website and onscreen display (lower right).

### (Sitemap)

(Images of Website Mockup with Display Examples)

In one embodiment, an application according to the present invention briefly displays text messages and images on the user's computer screen at programmable intervals and for programmable durations. No action is required to remove the message from the screen.

The messages and images can be easily created and bundled into sets of messages called “message sets.” These message sets can then be shared with others.

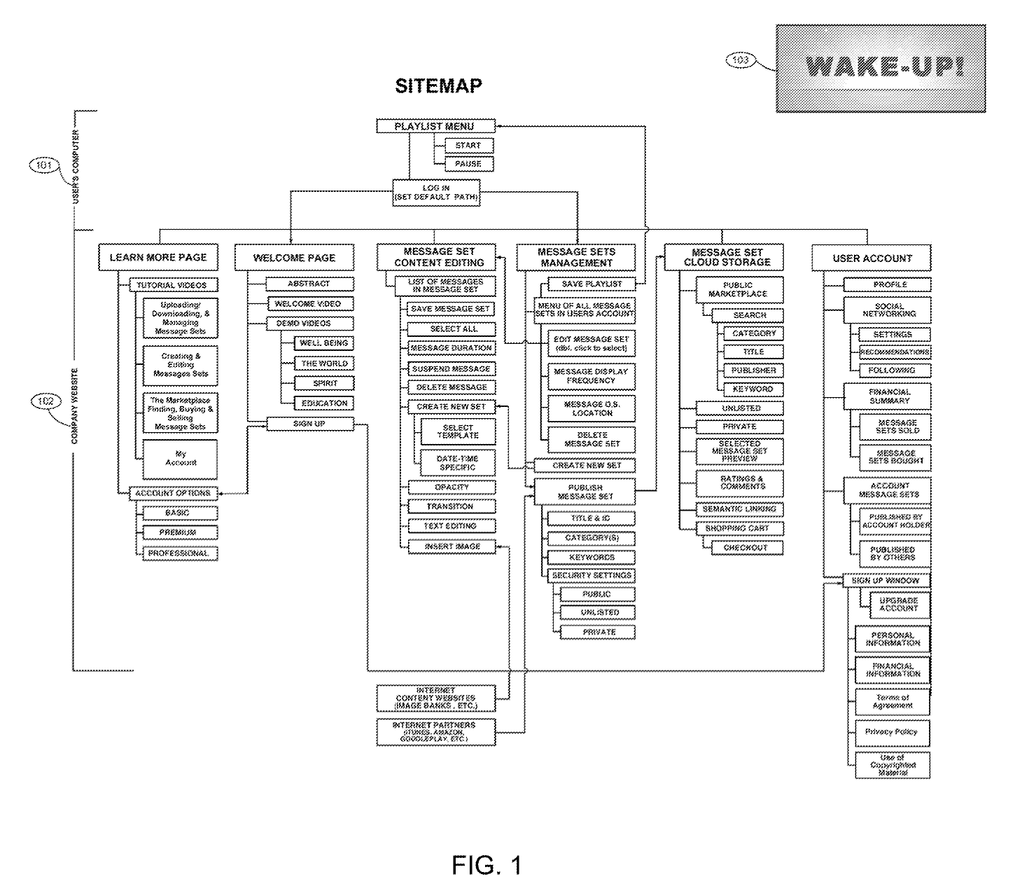

FIGS. 1-5 show one example of how the messaging system might be applied. This is a website called “Gentle Reminders.” The mockups show application's functions and are not meant to convey specific page layouts or styles. Each mockup illustration has an example of a message ((103) (211) (306) (414) (510) (606)). When the program is running the messages would appear on the user's screen, remain for a programmable period of time and then disappear.

As shown in FIG. 1, all the functions are browser based, except for the playlist itself, which runs on the user's device, independently from the internet. (101) Message sets are chosen or created, edited, published, shared, bought and sold, all through a browser-based program. (102)

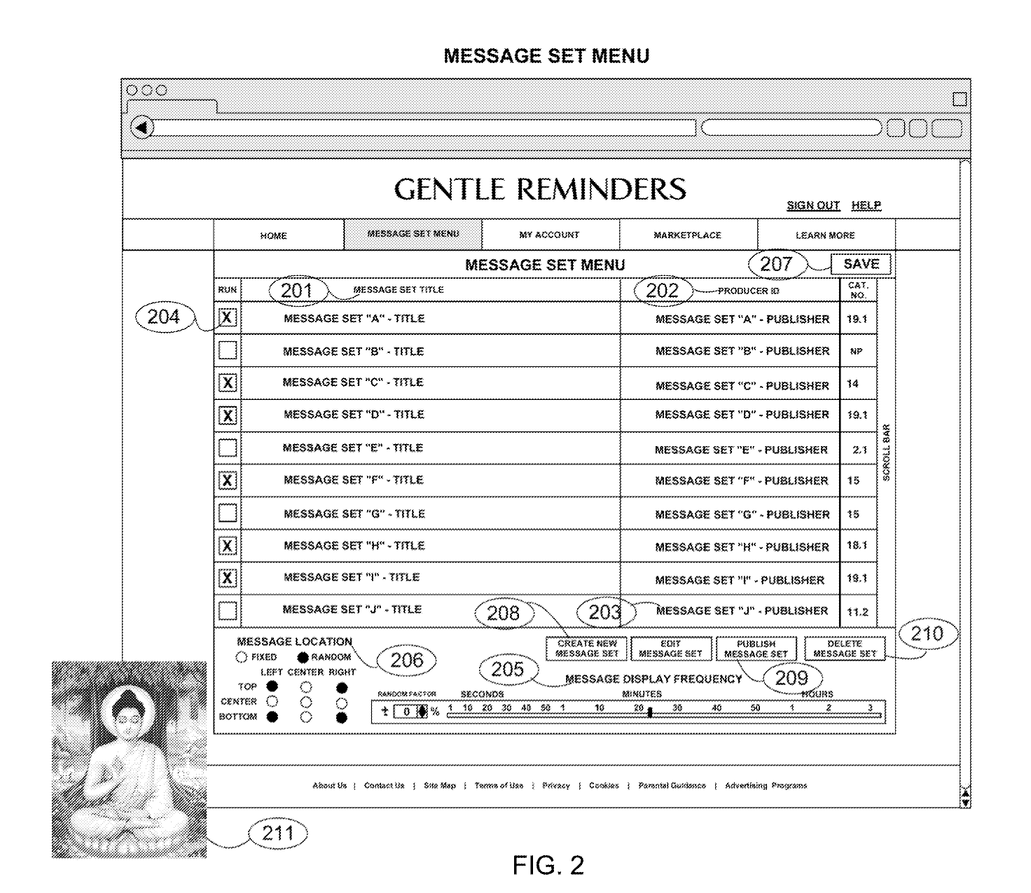

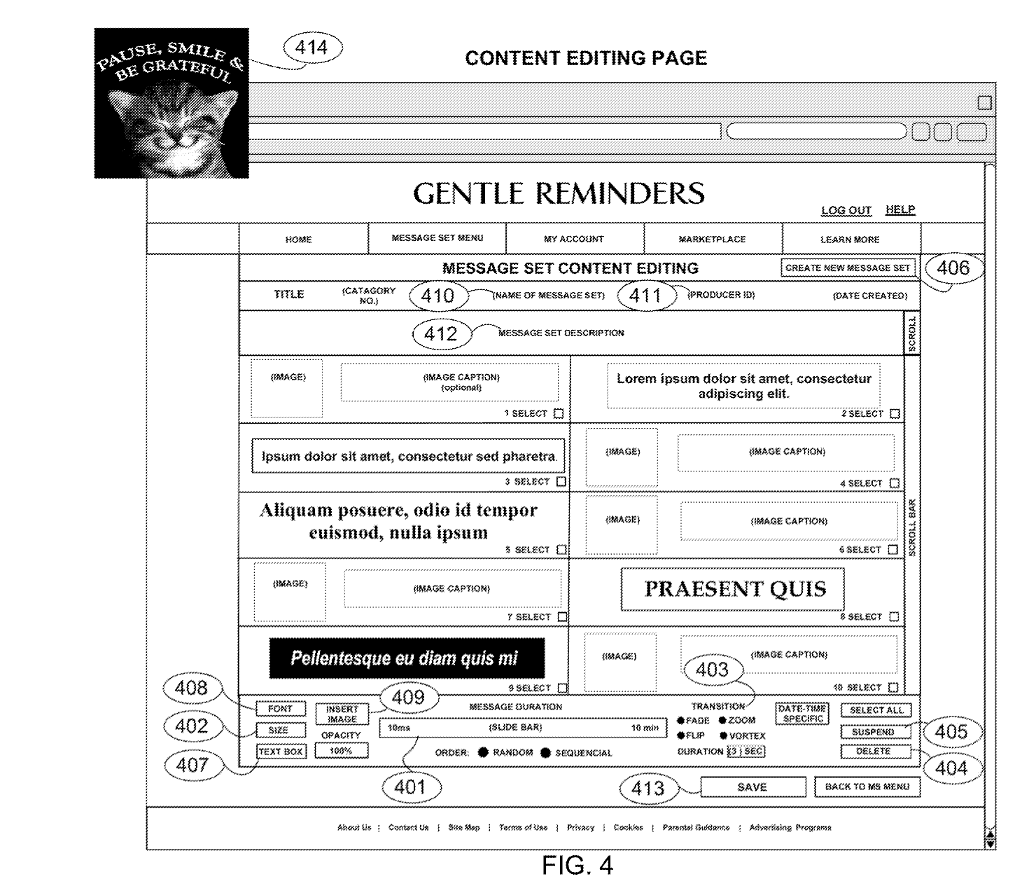

As shown in FIG. 2, registered account holders land on the Message Set Menu when they log-in from their computers. It has a list of all the message sets (201) that the account holder has created or downloaded from the Marketplace. The message sets are listed by title followed by the producer's ID. (202) Double clicking on the title, or highlighting the title and clicking “Edit Message Set,”(203) will open up that message set's edit page (FIG. 4). Checking the boxes in the left hand column (204) determines which message sets will be run on the user's computer.

On this page are also settings for the message display frequency (205) and the messages' display location on the screen. (206)

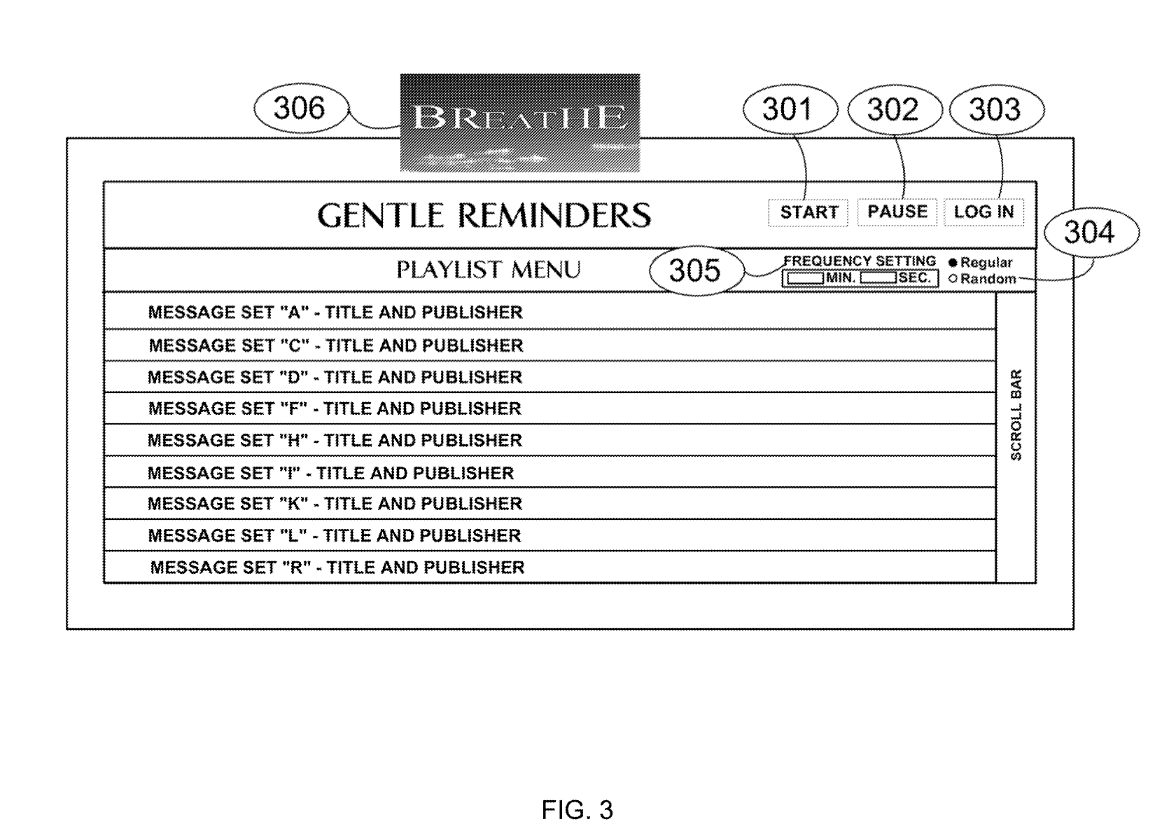

Once the user selects the message sets to run and chooses the settings, the “Save” button (207) is clicked and the current playlist downloads to the user's computer (FIG. 3).

Clicking the “Create New Message Set” button (208) opens a blank “Content Editing Screen (similar to FIG. 4).

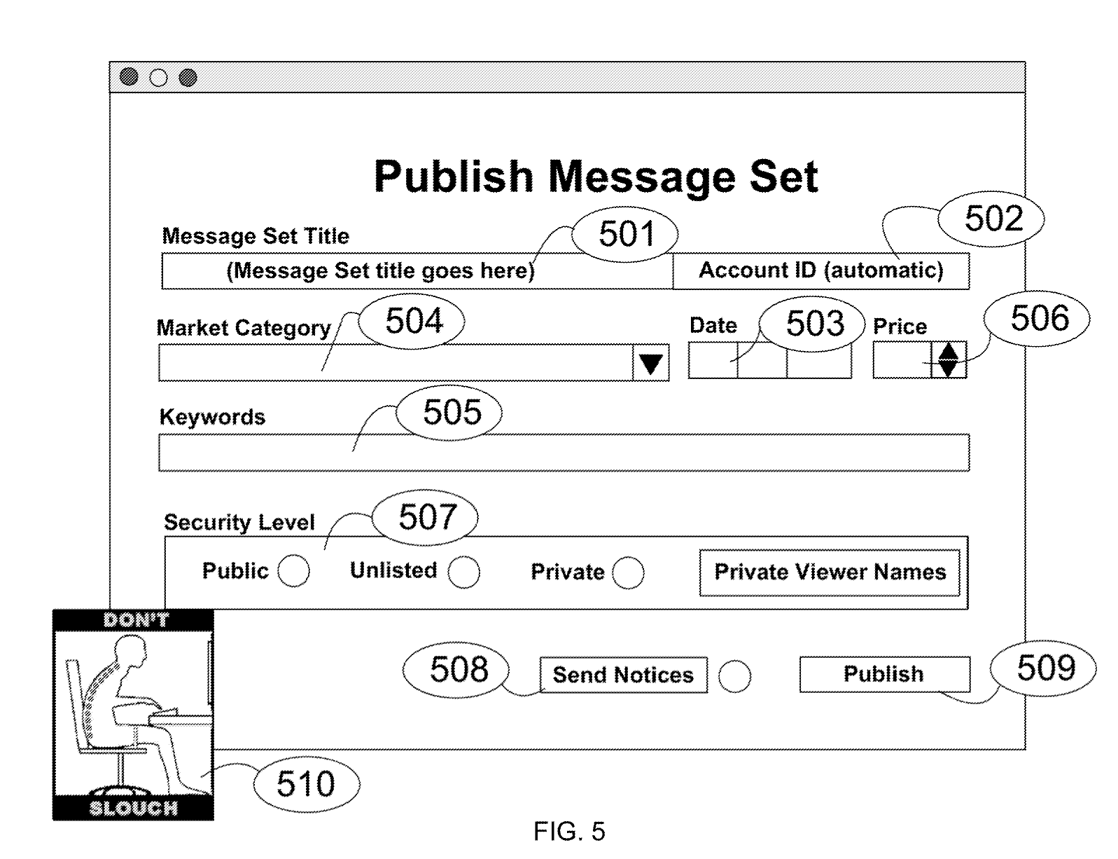

The Publish Message Set window (FIG. 5) opens when a message set that the user created is highlighted and the “Publish Message Set” button (209) is clicked.

Unwanted Message Sets may be deleted by highlighting the particular message set and clicking the “Delete Message Set” button. (210)

FIG. 3 shows a Playlist Menu that opens on the user's screen when the company icon is selected from the dock or application folder. It lists the message sets that will be running on the user's computer, until the selections are changed through the Message Set Menu (FIG. 2). The buttons on the Playlist Menu are Start (301), Pause (302) and Login (303). Messages can be set to appear in sequential order or random order (304).

The time interval at which the messages display (frequency) is shown (305) on the Playlist Menu, but the setting can only be changed from the Message Set Menu.

FIG. 4 shows a Message Set Content Editing page where the account holder creates, views and edits particular message sets. The content of message sets produced by the account holder is fully editable, as is its duration (401), size (402), and transition (403). Particular messages may also be deleted (404).

The content of messages produced by other account holders cannot be edited. Their messages and images may be suspended (405) from the display, but not deleted.

Clicking on the “Create a Message Set” button (406) opens a blank Content Editing page. Messages are composed by typing text (click X “Text Box” (407) and “Font” (408)), or pasting images from your files or browser (using the “Insert Image” button (409). The title of the newly created message set is entered (410), and the account holder's unique producer ID is automatically appended (411). Anything can be entered in the Message Set Description (412): a description of the message set contents and settings, information and links concerning the producer, etc.

Clicking the “Save” button (413) sends the new message set to the Message Set Menu (FIG. 2), from where it may be published or selected to run on the user's computer.

FIG. 5 illustrates a scheme where account holders may only publish message sets of their own creation. The Title of the Message Set (501) is entered, and user's ID (502) and the date (503) are automatically entered. The user chooses the Marketplace Categories (504), enters Keywords (505), sets the price (506) and chooses the security level—public, unlisted, or private (507).

Clicking the “Send Notices” button (508) opens a window where email addresses can be entered and notices automatically sent to whomever the publisher wishes to inform about the newly published set.

Clicking the “Publish” button (509) sends the message set to the appropriate area of the cloud storage (Public Marketplace, Account Holder's Unlisted or Private area).

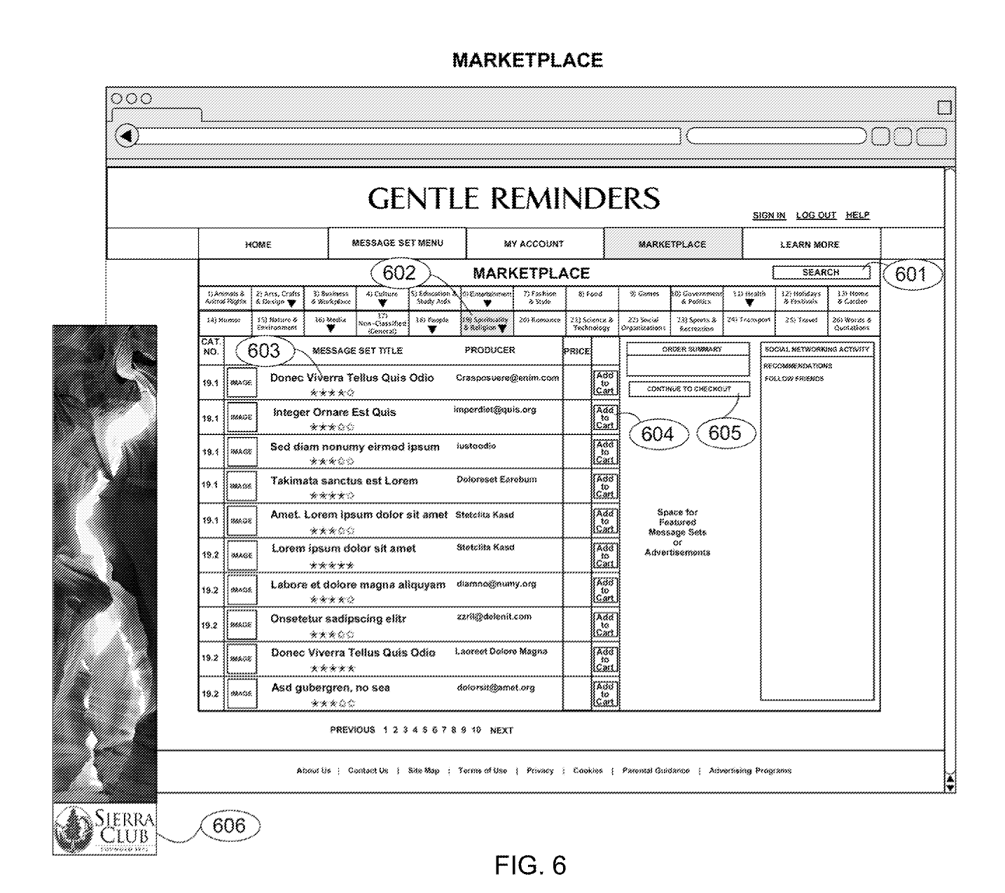

FIG. 6 illustrates a Marketplace which has all the publically listed message sets. There are search engine options (601) arranged by subject category (602), title, keywords, and by publisher.

If the message set has a security level that is unlisted or private, it won't appear in the Marketplace. It is up to the producers who created unlisted and private message sets to distribute them to their clientele, members, or friends.

When a customer in the Marketplace clicks on a title (603), a window appears displaying that message set's content, user reviews, and comments.

To download a message set to the user's Message Set Menu (FIG. 2), the user clicks the Add to Cart button (604) adjacent to the title/ publisher line. Clicking on “Continue to Checkout” (605) opens the checkout page connected to the user's account.

### The Message Set Menu.

The “Message Set Menu” window may be opened from the program's toolbar. The menu lists all the message sets that have been created or downloaded onto one's computer. The order of the title list is managed by clicking and dragging. A message set is comprised of a number of various text messages, images and audio messages usually composed around a theme or subject. From the “Message Set Menu” window one can import preprogrammed message sets from the Gentle Reminder's website marketplace. Message sets can also be created on the account holder's computer and uploaded to the website's marketplace. By clicking in the “Run” column of Message Set Menu window one picks which Message Sets will run on one's computer screen. The “Message Set Menu” window also contains controls for some of the display options, such as: the time interval (frequency) between the message displays and what area or areas on the screen the messages will appear. Clicking the “Start” button begins the displaying of messages on one's screen. Clicking the pause button suspends the running of the program until the start button is clicked again. The “Publish” button opens the “Publish Message Set” window. This is for uploading account holders' created messages sets to the website Marketplace. Highlighting its Title in the list and clicking the Edit button opens the “Content Menu” window where that specific message set may be edited. To add a new message set to the Message Set Menu—click the “New” button and the “New Message Set” window opens. From here one can import preprogrammed message sets from the website's marketplace or design and create new message sets. Clicking the Import button allows the account holder to browse the Marketplace. When a message set name is entered for a created message set the account holder's account ID is added to the end of the Title. Clicking the submit button closes the “New Message Set” window and the name of the new message set automatically appears in the “Message Set Menu”. Content Menu Window Using the “Content Menu” window one can add, delete and change the order of messages in a particular message set. The length of time the message appears on the screen is adjusted here along with adjustments to the font (size, color, opacity). The type of transition onto and off of the screen is also adjusted from here. One may make changes to both one's own created message sets and to the preprogrammed sets imported from the marketplace. The title of the message set appears at the top along with the account ID of the person who created it. Below this—all the messages in the set, are listed. A new message is inserted by typing or pasting it in the blank space that appears at the bottom of the list. Clicking and dragging the message to the place in the queue rearranges the order of the messages. Once the message set is programmed to the desired parameters the “Save” button is clicked and message set will saved as it has been edited.

The ability to share message sets with others is what make this invention more exciting than the few other mindfulness apps that are available. This model fulfills the desire of computer users to be reminded and inspired while at the same time fulfilling the need of businesses and organizations to remind and inspire their followers by propagating their ideas. Creators and users can register on the website, opening an account with a credit card or other payment account. After registering on the company's website, account holders can download the software to run messages on their home computers and mobile devices. Account holders can also create and publish message sets of their own, as explained above. Using the “Publish Message Set” window a message set can be uploaded to the website's marketplace. The name of the message set and the account holder's ID will automatically show in the Title on the Marketplace list. The account holder can only publish message sets they created. When the message set is published, that can trigger an automatic “upload” fee that will be deducted from the account holder's (publisher's) account and transferred to the website company's account. When the message set is published the account holder sets its selling price. The message set can be listed to sell for any price from free on up. By picking a privacy setting (public, unlisted, private) the message set will go into the appropriate area of the marketplace. Account holders can download message sets from the marketplace for the listed price. A download fee can be automatically triggered by the download and transferred from publisher's account to the company's account for each message set sold. The selling price minus the download fee will automatically be deposited in the publisher's account. This arrangement can potentially be a source of revenue for message set creators—particularly for organizations selling message sets to their members.

### Additional Embodiments

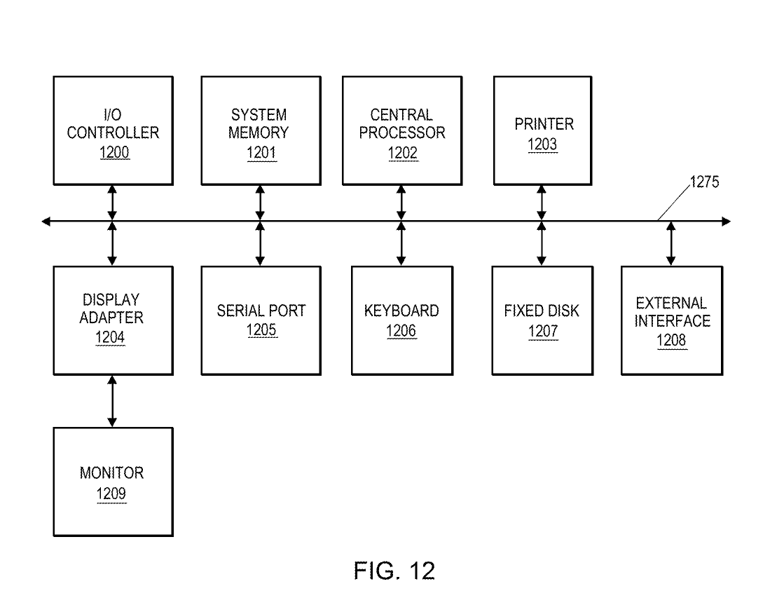

FIG. 12 is a high level block diagram of a computer system that may be used to implement any of the entities or components described above. The subsystems shown in FIG. 12 are interconnected via a system bus 1275. Additional subsystems include a printer 1203, keyboard 1206, fixed disk 1207, and monitor 1209, which is coupled to display adapter 1204. Peripherals and input/output (I/O) devices, which couple to I/O controller 1200, can be connected to the computer system by any number of means known in the art, such as a serial port. For example, serial port 1205 or external interface 1208 can be used to connect the computer apparatus to a wide area network such as the Internet, a mouse input device, or a scanner. The interconnection via system bus 1275 allows the central processor 1202 to communicate with each subsystem and to control the execution of instructions from system memory 1201 or the fixed disk 1207, as well as the exchange of information between subsystems. The system memory 1201 and/or the fixed disk may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

What is claimed is:

1. A server computer system for a message marketplace comprising:
a processor; and
a non-transitory computer readable medium comprising code, executable by said processor, to implement a method comprising:
uploading message sets provided by a plurality of creator;
displaying said message sets;
provided selected message sets to a customer;
displaying said message sets to said customer in accordance with parameters selected by said customer.
